(19) United States
(12) Patent Application Publication
(10) Pub. No.: US 2019/0305415 A1
(43) Pub. Date: Oct. 3, 2019

(54) INTEGRATED MULTI-STANDARD ANTENNA SYSTEM WITH DUAL FUNCTION CONNECTED ARRAY

(71) Applicant: King Fahd University of Petroleum and Minerals, Dhahran (SA)

(72) Inventors: Mohammad S. Sharawi, Dhahran (SA); Muhammad Ikram, Okara (PK); Rifaqat Hussain, Dhahran (SA)

(21) Appl. No.: 15/938,817

(22) Filed: Mar. 28, 2018

(51) Int. Cl. H01Q 1/52; H01Q 21/06; H01Q 9/04; H01Q 1/24; H01Q 21/00

(52) U.S. Cl. CPC H01Q 1/523; H01Q 21/064; H01Q 21/0075; H01Q 21/065; H01Q 1/243; H01Q 9/0421

(57) ABSTRACT

A compact, low profile integrated antenna design covering both 4G and 5G applications with good performance and that fits in handheld mobile terminals. The antenna design is a PIFA-based MIMO antenna system for 4G standards integrated with a planar connected array (PCA) for 5G bands. The antenna is fabricated on a two-layer printed circuit board (PCB) accommodating four antenna elements (3, 4, 5 and 6) along with a planar connected array (9) on a top layer, and a plurality of parallel slots (12) forming a defected ground structure in a bottom layer. The integrated antenna has approximately a typical smart phone backplane size. The plurality of parallel slots behave as a defected ground structure (DGS) for isolation enhancement within the MIMO antenna system band at 2.1 GHz and as a radiator (PCA) for 5G applications at 12.5 GHz.

### FIELD OF THE INVENTION

This invention relates generally to the field of integrated multi-standard and multi-band 4G and 5G-enabled wireless communication systems for wireless handheld devices and mobile terminals. More particularly, it relates to an integrated design with a multiple-input multiple-output (MIMO) antenna system for 4G applications, and a planar connected array (PCA) for 5G applications.

### BACKGROUND OF THE INVENTION

Multi-function antennas are highly desirable for wireless communication devices. Multiple-input multiple-output (MIMO) antenna systems are used in fourth generation (4G) devices to enhance the data rate and will also be used in future standards like fifth generation (5G) devices. To meet the high data rate demands in upcoming wireless standards, researchers are working on 5G communication systems. The 5G systems will provide 1000 times the capacity of 4G systems. A study is ongoing within the international communication unit (ITU), indicating that frequency bands for 5G will be above 6 GHz to make use of higher available bandwidths.

MIMO antenna systems have been adopted to increase the wireless channel capacity and reliability of data requirements. The key feature of a MIMO antenna system is its ability to multiply data throughput with enhanced data reliability using the available bandwidth, hence resulting in improved spectral efficiency.

Planar inverted-F antennas (PIFA) are widely used due to their compactness in size, ease of fabrication and ease of integration. Several PIFA-based MIMO antenna systems with four or more elements, have been proposed for handheld devices. Connected array antenna systems have been introduced recently, with their main feature being a wide band of operation.

Exemplary prior includes the systems disclosed in issued U.S. Pat. No. 8,659,500 to Wu, and in published US patent applications to Sharawi (US 2017/0141465) and Sunderarajan et al. (US 2017/0062952).

Wu (U.S. Pat. No. 8,659,500) discloses a multi-antenna 10 which may be utilized in a multi-input-multi-output (MIMO) wireless communication system for performing radio signal transmission and reception. The multi-antenna 10 includes a substrate 100, planar antennas 1.02 and 104, and a vertical antenna 106. The planar antennas 102 and 104 are formed on the substrate 100 by etching or printing, for realizing monopole antennas. (See figures and col.1, lns.66-col.3, lns.18).

Sharawi (US 2017/0141465) discloses an integrated microwave-millimeter wave antenna system with isolation enhancement mechanism that is a planar, compact, multi-band microwave multiple-input multiple-output (MIMO) antenna system integrated with a millimeter wave antenna array. The planar slot array 109 will act as an isolation enhancement structure for the MIMO antenna system at microwave frequencies, as well as a millimeter wave antenna array at millimeter wave frequencies. The bottom layer 115 contains the feed network of the millimeter wave slot antenna array 109 of the second substrate layer. The feed arms 112 form a power divider feed network 130 and are fed via an impedance transformer 113 in operable communication with a connector 114. (See paragraphs [0022]-[0030] and related figures).

Sunderarajan et al. (US 2017/0062952) disclose a dual-band dual-polarized antenna module arrangement for receiving and transmitting electromagnetic signals comprising antenna element feeds coupled between the third set of four planar antenna elements and a transceiver front end configured to provide 4.times.4 multiple input multiple output (MIMO) operation. (See paragraphs [0025]-[0035] and related figures)

To applicant's knowledge, no one has developed an integrated antenna design with a multiple-input multiple-output (MIMO) antenna system for 4G applications and a planar connected array (PCA) for 5G applications, wherein the PCA also serves as a defected ground structure (DOS) at 2.1 GHz, thus having two functions.

### SUMMARY OF THE INVENTION

The present invention is an integrated antenna design covering both 4G and 5G applications with good performance and that fits in handheld mobile terminals.

The integrated antenna is a PIFA-based MIMO antenna system for 4G standards and a planar connected array (PCA) for future 5G bands. The planar structure of the proposed design, fabricated on a two layer printed circuit board (PCB), is compact and low profile, accommodating four antenna elements along with a planar connected array in an area of a typical smart phone backplane size. Moreover, the proposed design is the first to present a dual function slot array that behaves as a defected ground structure (DGS) for isolation enhancement within the MIMO antenna system band at 2.1 GHz and as a radiator (PCA) for 5G applications at 12.5 GHz.

The PIFA based MIMO antenna system contains four elements, and the planar connected array (PCA) is slot based. The dimensions of the board used are 100×60×0.76 mm, which is a typical smart phone backplane size. The antenna system covers 2.1 and 12.5 GHz frequency bands via its MIMO and PCA, respectively. It is a planar, low profile and compact structure suitable for wireless handheld devices and mobile terminals. The PCA also serves as a defected ground structure (DGS) at 2.1 GHz, thus having two functions, as further shown and described in the following detailed description.

More specifically, the antenna design of the invention is a multiple-input multiple-output (MIMO) antenna system for 4G applications integrated with a planar connected array (PCA) for 5G applications. The proposed design contains a 4-element printed inverted F antenna (PIFA) based MIMO antenna system and a slot based PCA. The antenna system is fabricated on a commercially available RO-4350 substrate with Er equal to 3.5. The dimensions of the board are 100×60×0.76 mm, representing a typical smart phone backplane size. The antenna system covers 2.1 and 12.5 GHz frequency bands via its MIMO and PCA, respectively. The design is planar, low profile and compact in structure, suitable for wireless handheld devices and mobile terminals. The PCA also serves as a defected ground structure (DGS) at 2.1 GHz, thus having two functions. Isolation is improved by at least 4 dB. The PCA consists of 4×3 radiating slots fed via a corporate feed structure wherein the antenna elements are fed by a power divider network with identical path lengths from the feed point to each element. The measured gain and efficiency values at the center frequency were at least 3.4 dBi and 74%, respectively for the MIMO antenna system and 8 dBi and 80% for the PCA. The Envelope correlation coefficient (ECC) is also calculated from the measured 3D patterns and it was less than 0.2824 for all antenna elements showing good MIMO performance.

### BRIEF DESCRIPTION OF THE DRAWINGS

The patent or application file contains at least one drawing executed in color. Copies of this patent or patent application publication with color drawings will be provided by the Office upon request and payment of the necessary fee.

The foregoing, as well as other objects and advantages of the invention, will become apparent from the following detailed description when taken in conjunction with the accompanying drawings, wherein like reference characters designate like parts throughout the several views, and wherein:

FIG. 1(a) shows the geometry of the top layer substrate of the board in the 4-element slotted MIMO antenna system according to the invention.

FIG. 1(b) shows the geometry of the bottom layer ground plane of the board in the 4-element slotted MIMO antenna system of the invention.

FIG. 2 is an enlarged plan view of the defected ground structure (DGS) used in the antenna system of FIGS. 1(a) and 1(b).

FIGS. 3(a) and 3(b), respectively, show the magnitude and phase curves of the transmission coefficient between the PCA input to the output ports.

FIGS. 4(a) and 4(b) show the simulated and measured reflection coefficient curves, respectively, of the antenna without PCA.

FIGS. 4(c) and 4(d) show the simulated and measured isolation curves, respectively, of the antenna without the PCA.

FIGS. 5(a) and 5(b) show the simulated and measured reflection coefficient curves, respectively, of the integrated antenna design.

FIGS. 5(c) and 5(d) show the simulated and measured isolation curves, respectively, of the integrated antenna design.

FIG. 6(a) shows the simulated and measured reflection coefficients of the PCA.

FIG. 6(b) shows the measured isolation curves between the PCA and MIMO antenna system.

FIGS. 7(a) and 7(c) are two-dimensional ϕ-cuts for each antenna at θ=90°.

FIGS. 7(b) and 7(d) are two-dimensional ϕ-cuts at θ=60° for all MIMO antennas.

FIG. 7(e) shows the two-dimensional patterns in terms of Etotal for the PCA at 12.5 GHz ϕ-cuts at θ=0°.

FIG. 7(f) shows the two-dimensional patterns in terms of Etotal for the PCA at 12.5 GHz ϕ-cuts at θ=90°.

FIG. 8 shows the curves of maximum gain and efficiency versus frequency for the PCA.

### DETAILED DESCRIPTION OF THE PREFERRED EMBODIMENTS

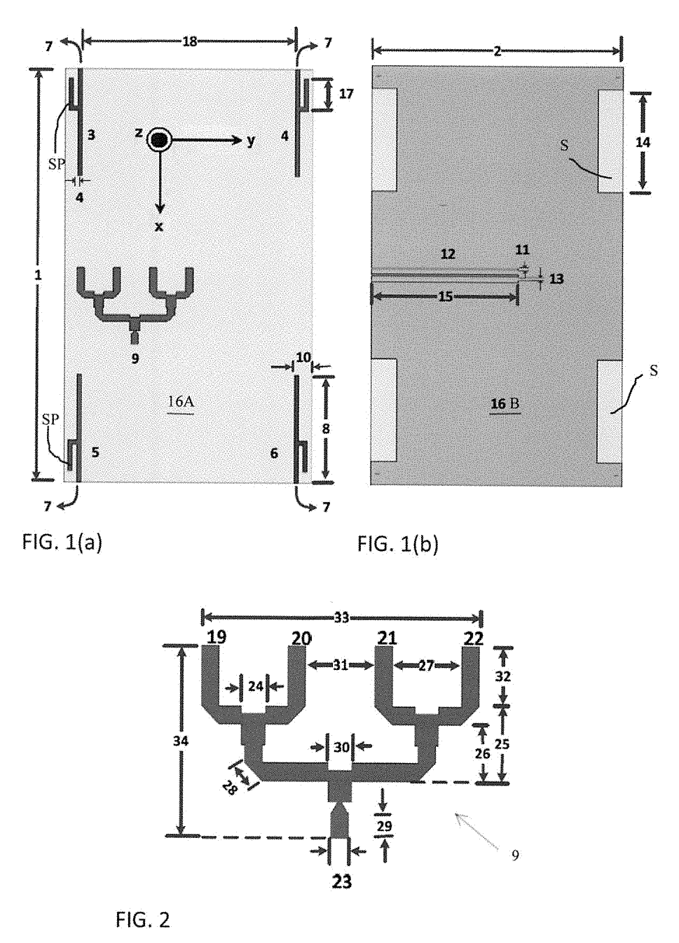

The HFSS™ model of a 4G/5G integrated MIMO antenna system is shown in FIGS. 1(a) and 1(b). FIG. 1(a) shows the dielectric top layer substrate 16A of the board containing four modified monopole antenna elements 3, 4, 5 and 6, respectively, and a Planar Connected antenna Array (PCA) feeding network 9. All the 4G MIMO antenna elements are etched on the four corners of the top side of the substrate 16A,

The bottom layer ground (GND) plane 16B is on the bottom side of the substrate 16A. All the antenna elements are short-circuited with the GND plane using shorting pins SP to increase the electrical length. As shown in the bottom right-hand corner of FIG. 1(a), the length and width dimensions 8 and 10 of an antenna element are 27 mm and 6 mm, respectively, which is around lambda/4 at 2.1 GHz.

The lateral spacing 18 between antenna elements is 47.92 mm. This spacing is less than lambda/2 (lambda=λ), which yields low isolation between them. The given antenna elements are fed by SMA connectors 7. One possible prototype for the antennas is fabricated on a dielectric substrate with relative permittivity (∈ᵣ) equal to 3.5 and a height of 0.76 mm. The four antenna elements are fabricated on the substrate, which in the particular example disclosed, has length and width dimensions 1 and 2 of 100 mm and 60 mm, respectively. Any type of substrate can be used, but the antenna sizes should be adjusted according to the application at hand and the bands of interest, but the procedure is general.

To improve MIMO port efficiency, isolation enhancement via a defected ground structure (DGS) is used. Slots 12 in the GND plane (see FIG. 1(b)) are used as a DGS. These slots are optimized by their length and number to enhance the isolation at 2.1 GHz. The best results are obtained using three slots, as shown. Each slot has a length 15 of 35 mm and a width 11 of 0.5 mm, and the spacing 13 between them is 0 5 mm. The DGS was placed between antennas 3, 4 and antennas 5, 6 to enhance isolation between them. The length 14 of slots S is 24.6 mm and the length 17 of shorting pins SP is 7.5 mm. These slot sizes were optimized based on the substrate used and the band chosen. Other sizes can be used when using other material or different targeted frequency bands.

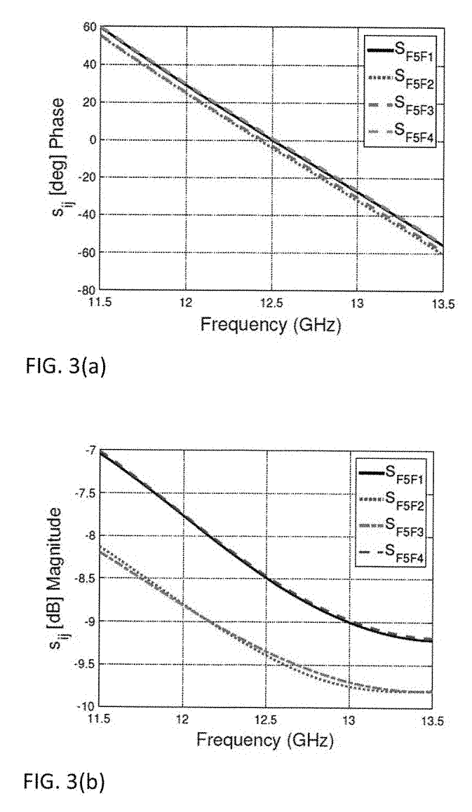

GND slots 12 in the MIMO antenna system were also utilized to implement the planar connected array (PCA) feed network 9. As shown in greater detail in FIG. 2, the feed network comprises a 1-to-4 line power combiner/divider 9 designed on the top layer substrate 16A to excite the slots 12 in the bottom layer ground plane 16B and make them radiate at 12.5 GHz. The feed network 9 is optimized to provide constant phase and equal magnitude at its four output ports 19, 20, 21 and 22. The magnitude and phase curves of the transmission coefficient between 23 (PCA input) to output ports 19, 20, 21 and 22 are shown in FIGS. 3(a) and 3(b), respectively.

There is less than 1 dB amplitude difference between the inner and outer branches of the feed network at 12.5 GHz due to slight path length differences. The phases are almost the same. The width of branches 19-22 and microstrip-line 23 is 1.8 mm to give 50 Ω lines, while 24 is set to 2.4 mm to provide 35 Ω,λ/4 transformers. These transformers are used to convert 25 Ω to 50 Ω. The location of the feed network is also optimized along the slots (y-axis) to match for 50 Ω on the PCA as well as to maintain isolation improvement. The spacing 27 between the feed lines is 6.95 mm, which is around λ/4 at 12.5 GHz, to excite the slots periodically as a connected array. Transmission matching techniques (bends and T junctions) are applied in the feeding network to improve the matching. The various dimensions of the feed networks 25, 26, 27, 28, 29, 30, 31, 32, 33 and 34 are 5.5 mm, 6.175 mm, 7.3 mm, 2 54 mm, 2.5 mm, 2.4 mm, 6.95 mm, 5.7 mm, 28.05 mm, 18.5 mm, respectively.

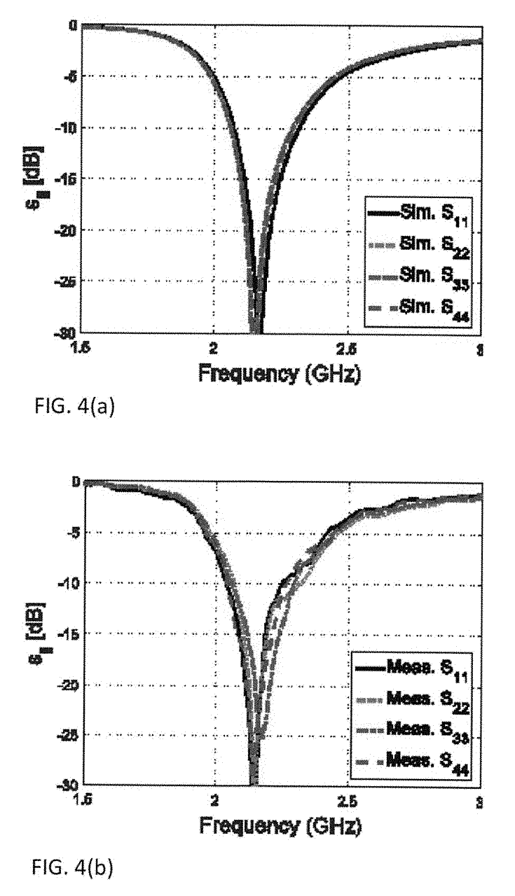

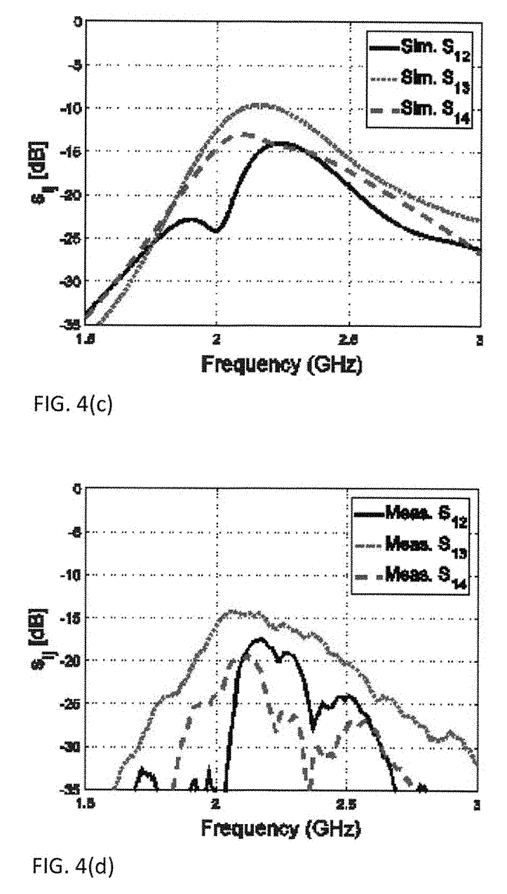

The simulated reflection coefficient curves of the antenna without PCA are shown in FIG. 4(a), while FIG. 4(b) shows the measured reflection coefficient curves. All the resonance curves show that the 4-elements of the MIMO antenna system resonate at 2.1 GHz. The measured minimum −10 dB bandwidth was 217 MHz from 2040 MHz to 2257 MHz.

The simulated and measured isolation curves without the PCA of the MIMO antenna system are shown in FIGS. 4(c) and 4(d), respectively. The worst case simulated isolation value of 9.5 dB was observed between antenna elements 3 and 5, while it was 13 dB between elements 3 and 4.

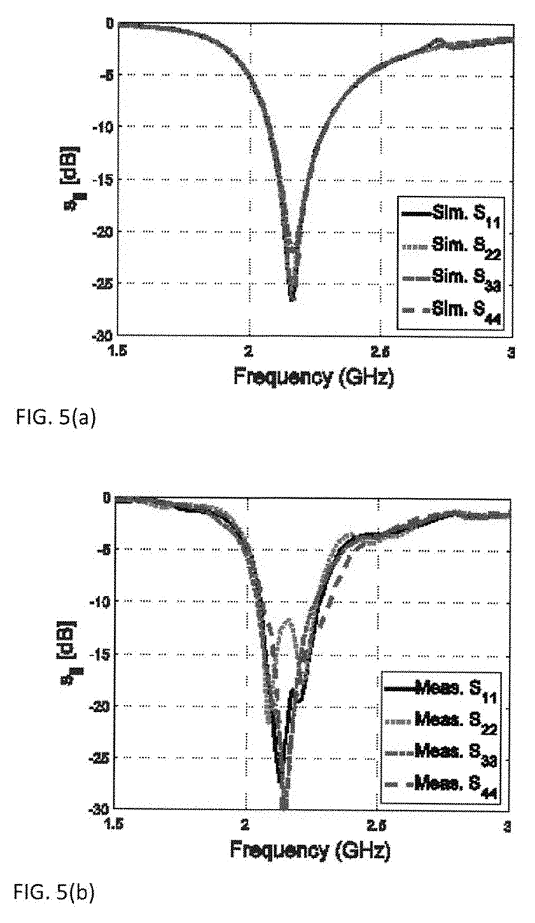

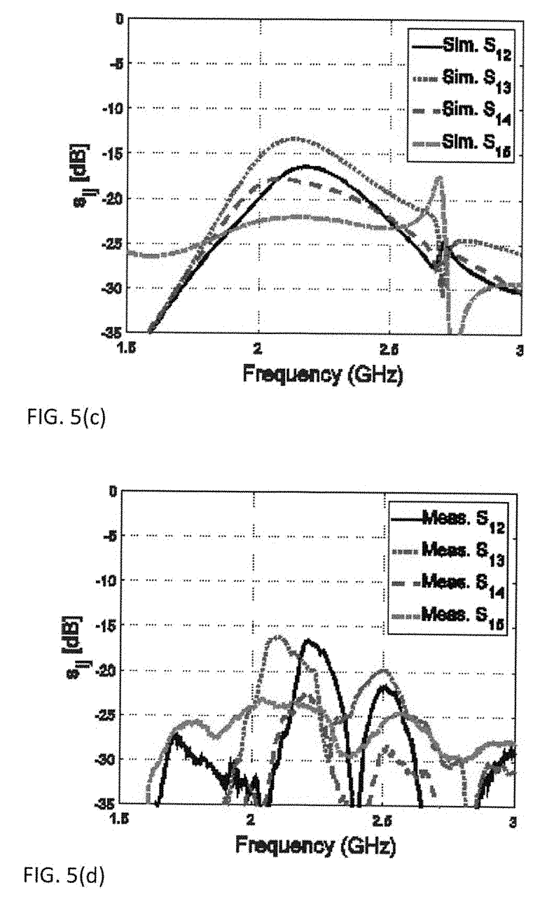

The simulated reflection coefficient curves of the integrated antenna design are shown in FIG. 5(a), while FIG. 5(b) shows the measured reflection coefficient curves. The simulated and measured isolation curves of the proposed integrated design are shown in FIGS. 5(c) and 5(d), respectively. The measured bandwidth covered was 205 MHz from 2058 to 2263 MHz. The worst case simulated isolation value of 13.5 dB was observed between antenna 3 and antenna 5, while it was 17 dB between antennas 3, 5 and antennas 4, 6. A 4 dB extra isolation was achieved using the DGS (PCA). The improvement in isolation can also be observed in the measured curves in FIGS. 5(c) and 5(d).

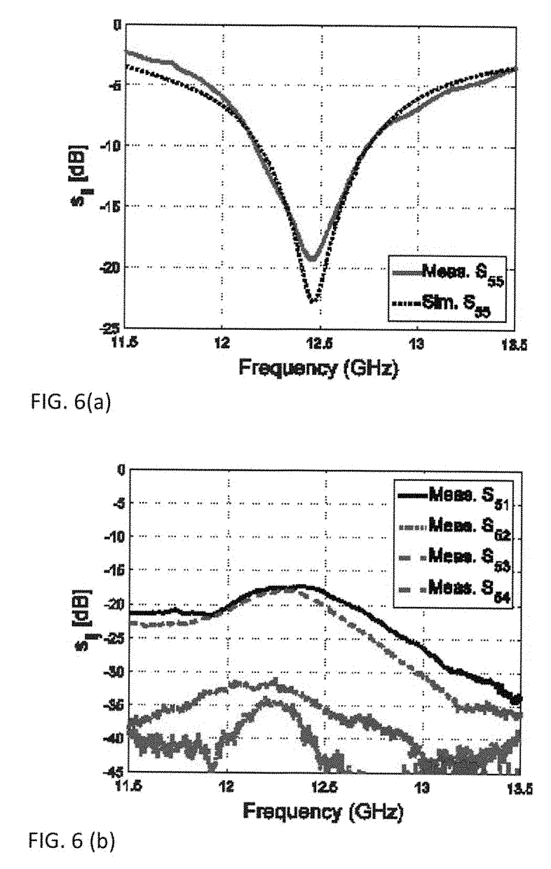

The simulated and measured reflection coefficients of the PCA are shown in FIG. 6(a). The resonance curves show that the PCA resonates at 12.5 GHz. The measured minimum −10 dB bandwidth achieved was 580 MHz from 12.17 to 12.75 GHz. A good agreement between simulated and measured results was obtained. The measured isolation curves between the PCA and the MIMO antenna system are shown in FIG. 6(b), which shows high isolation (more than 16 dB) between them.

The normalized simulated and measured 2D radiation patterns in terms of Etotal for the MIMO antenna system at 2.1 GHz are illustrated in FIG. 9 for the x-y and y-z planes (with reference to FIG. 1). The maximum measured values of Etotal for all four antenna elements, 3, 4, 5 and 6, were 3.71 dB, 3.16 dB, 3.31 dB and 3.43 dB, respectively. The figure shows that the beam maxims are tilted due to the presence of the GND that acts as a reflector. This is advantageous in that it lowers the ECC values. The maximum value of Etotal for the PCA was 8.3 dB. The slightly titled beam of the array is due to the asymmetry end termination of the slot array.

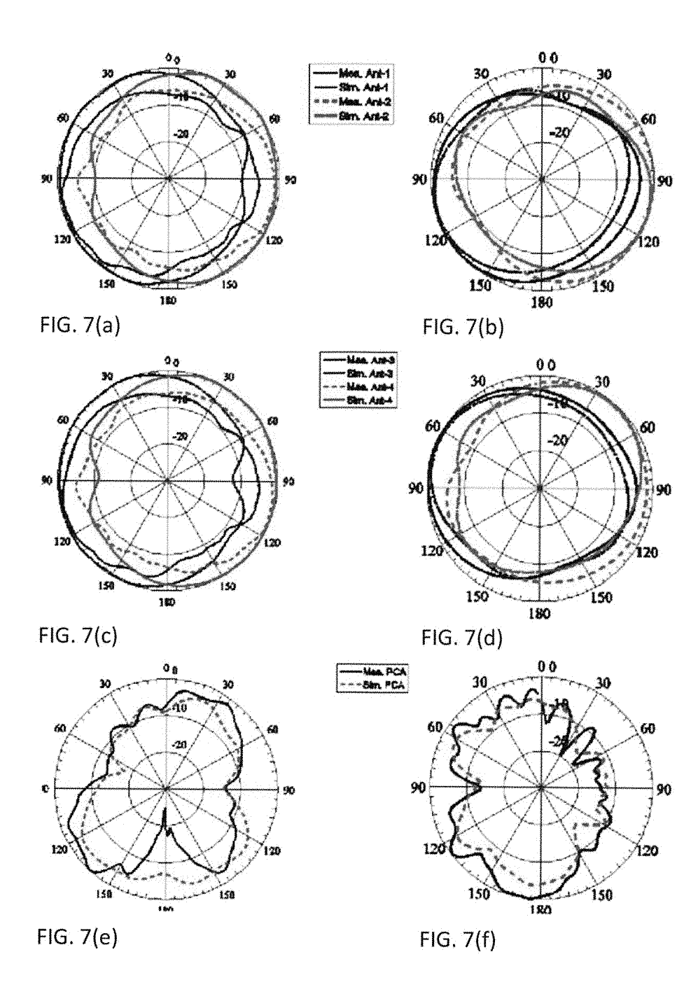

As shown in FIGS. 7(a) and 7(c), 2-D θ-cuts are plotted for each antenna at θ=90°. FIGS. 7(b) and 7(d) show 2-D ϕ-cuts at ϕ=60° for all MIMO antennas. The beam tilts are clear.

The 2D patterns in terms of Etotal for the PCA at 12.5 GHz are shown in FIGS. 7(e) and 7(f). FIG. 7(e) shows the θ-cuts at ϕ=0°, while FIG. 7(f) shows ϕ-cuts at θ=90°. The beam tilt as well as the radiation maximums are opposite to the location of the feed network.

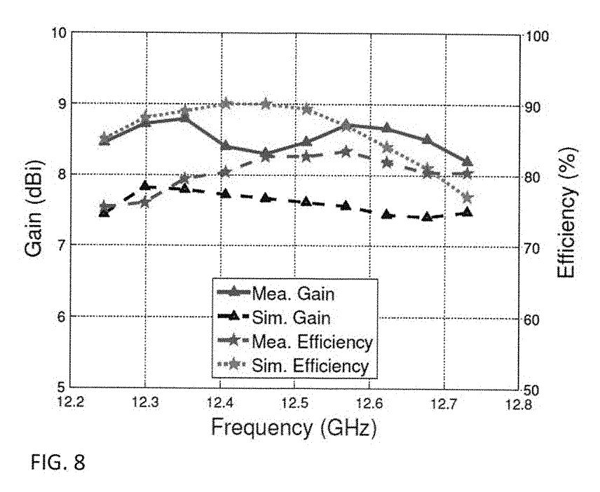

The simulated maximum gains observed for the proposed integrated design were 3.3 dBi, 2.2 dBi, 3.2 dBi, 2.2 dBi and 7.6 dBi for antenna 3-antenna 6 and PCA 12, at 2.1 GHz and 12.5 GHz, respectively. The minimum efficiency at 2.1 GHz was 74%. Differences between measured and simulated gains did not exceed 1.5 dBi across the complete band of operation for all antennas. The curves of maximum gain and efficiency versus frequency for the PCA are shown in FIG. 8 and were 8.5 dBi and 83% at 12.5 GHz, respectively. Differences between measurements and simulation did not exceed 1 dB across the complete band covered.

The envelope correlation coefficient (ECC) values were computed based on the measured 3D radiation patterns with maximum obtained values of 0.2005, 0.2495 and 0.0623 between antenna elements 3 and 4, elements 3 and 5, and elements 3 and 6, respectively, at 2.1 GHz. All values are below 0.5, which shows that the proposed design can fulfill the requirements of a 4G MIMO antenna system.

While the invention has been described in connection with its preferred embodiments, it should be recognized that changes and modifications may be made therein without departing from the scope of the appended claims.

What is claimed is:

1. A low profile, planar, compact, integrated antenna design covering both 4G and 5G applications with good performance and that fits in handheld mobile terminals, comprising:
a two-layer board having a dielectric top layer substrate and a bottom layer ground plane;
a multiple-input multiple-output (MIMO) antenna system formed on the top layer for 4G applications, said MIMO antenna system based on a planar inverted-F antenna (PIFA); and
a dual function slot array on the bottom layer ground plane that behaves as a defected ground structure (DGS) for isolation enhancement within the MIMO antenna system band at 2.1 GHz and as a planar connected array (PCA) radiator for 5G applications at 12.5 GHz.

2. The integrated antenna design as claimed in claim 1, wherein:
the MIMO antenna system comprises four modified monopole antenna elements fabricated on the substrate in respective corners of the substrate.

3. The integrated antenna design as claimed in claim 2, wherein:
said slot array comprises extends into said ground plane from one side thereof at a location approximately midway between the ends of the ground plane; and
there are three said slots in said slot array, each said slot having a length of 35 mm, a width of 0.5 mm, and spacing between them of 0.5 mm, said slots improving MIMO port efficiency and enhancing isolation and being optimized by their length and number to enhance the isolation at 2.1 GHz.

4. The integrated antenna design as claimed in claim 3, wherein:
a 1-to-4 power combiner/divider line feed network is in said top layer in a position to overlie the slot array in said bottom layer ground plane, said feed network having four spaced apart feed line branches extending parallel to one another and forming four output ports optimized to provide constant phase and equal magnitude at the output ports, said output ports exciting the slots in the slot array and making them radiate at 12.5 GHz, said feed network being optimized to provide constant phase and equal magnitude at the four output ports.

5. The integrated antenna design as claimed in claim 4, wherein:
there is less than 1 dB amplitude difference between the inner and outer branches of the feed network at 12.5 GHz.

6. The integrated antenna design as claimed in claim 5, wherein:
a microstrip feed line is connected with the four branches.

7. The integrated antenna design as claimed in claim 6, wherein:
the location of the feed network is positioned along the length of the slot array to match for 50 Ω on the slot array as well as to maintain isolation improvement.

8. The integrated antenna design as claimed in claim 7, wherein:
the feed line branches are spaced apart 6.95 mm, which is about λ/4 at 12.5 GHz, to excite the slots periodically as a connected array.

9. The integrated antenna design as claimed in claim 8, wherein:
shorting pins short-circuit all the antenna elements with the bottom layer ground plane to increase the electrical length.
